(19) United States
(12) Patent Application Publication
(10) Pub. No.: US 2026/0179817 A1
(43) Pub. Date: Jun. 25, 2026

(54) Power Supply for Triggering a Solenoid in a Remote Breaker

(71) Applicant: ABB Schweiz AG, Baden (CH)

(72) Inventors: Chandrashekar Nagawaram, Hyderabad (IN); Madanambeti Manikandan, Hyderabad (IN)

(73) Assignee: ABB Schweiz AG, Baden (CH)

(21) Appl. No.: 18/987,137

(22) Filed: Dec. 19, 2024

(51) Int. Cl. H01F 7/06; G05F 1/56; H02M 1/08; H02M 3/24

(52) U.S. Cl. CPC H01F 7/064; G05F 1/56; H02M 1/08; H02M 3/24

(57) ABSTRACT

A circuit breaker includes a microcontroller, a voltage feedback circuit, and a power supply circuit electrically couplable to a power input, and including a switch and a solenoid. The power supply circuit is configured to activate the switch and electrically couple to the power input in response to a gate trigger signal, and to provide current to the one or more solenoids in response to a solenoid signal. The microcontroller is configured to issue, to the power supply circuit, the gate trigger signal for the power supply circuit to electrically couple at a first duty cycle, and the solenoid signal based on receiving a first indication from the voltage feedback circuit of a first voltage; receive, during the extension of the one or more solenoids, a second indication of a second voltage; and in response to the second indication, increase the first duty cycle to a second duty cycle.

### FIELD

The present disclosure relates to a circuit breaker device and system. In particular, the present disclosure relates to a power supply design for triggering a solenoid in a remote circuit breaker.

### BACKGROUND

A circuit breaker can be used to trip (e.g., disconnect) a circuit when overcurrent conditions occur to prevent damage and/or hazardous conditions such as fire or equipment failure. The circuit breaker can include a mechanical latch that, when closed, keeps electrical contacts of the mechanical latch in electrical connection with circuit (e.g., in the ‘on’ position) and conducting current within the circuit. When the mechanical latch is opened, the contacts are separated from the circuit of the circuit breaker, and the circuit of the circuit breaker no longer conducts current within the circuit. Solenoids can be used to open the mechanical latch, such as by extending and/or withdrawing and thereby pushing and/or pulling the mechanical latch open or closed. In other words, the contacts of the mechanical latch and/or circuit breaker can be forced apart to interrupt a flow of current when the solenoids are extended. The solenoid, including a coil wire inductor and a movable core (e.g., plunger), typically does not conduct enough current under normal operating conditions to generate a magnetic field strong enough to activate (e.g., extend) the plungers. When additional current is supplied to the solenoid, however, the inductor of the solenoid can generate a strong enough magnetic field to extend the movable core and open the mechanical latch of the circuit breaker.

However, for the direct current (DC) solenoid to extend, sufficient voltage needs to be provided to the solenoid to allow the solenoid to fully extend (e.g., because extension of the movable core can require a specific amount of provided voltage over the course extension). In some instances, when insufficient voltage is provided, the solenoid can fail to complete its full displacement, as the solenoid lacks enough force to overcome the magnetic force in the circuit breaker. In large applications, capacitors (e.g., acting similar to batteries) can be provided to adjust a pulse width of the solenoid (e.g., by storing enough power to extend the solenoids). However, for some solenoids, providing enough capacitors or large enough capacitors to provide sufficient voltage to the solenoids may present a high surface area and/or volume demand for the circuit, and can present additional cost burdens. In other applications, the DC voltage may be reduced to an insufficient voltage during the solenoid extension.

### SUMMARY

In some examples, the present disclosure provides a remote circuit breaker that receives power from an external electrical power input. The remote circuit breaker comprises a power supply circuit electrically couplable to the external electrical power input and a microcontroller, the power supply circuit comprising a switch and one or more solenoids, the power supply circuit configured to activate the switch and electrically couple to the external electrical power input in response to a gate trigger signal thereby receiving direct current (DC) voltage for the one or more solenoids, and configured to provide the DC voltage to the one or more solenoids for activating the one or more solenoids in response to a solenoid signal; a voltage feedback circuit electrically coupled between the power supply circuit and the microcontroller, the voltage feedback circuit configured to sample an output voltage of the power supply circuit when the power supply circuit is electrically coupled to the external electrical power input; and the microcontroller. The microcontroller configured to issue, to the power supply circuit, the gate trigger signal based on a trip event, wherein the power supply circuit electrically couples at a first duty cycle based on the gate trigger signal; issue, to the power supply circuit, the solenoid signal based on receiving a first indication from the voltage feedback circuit of the output voltage at a first voltage; receive, during the extension of the one or more solenoids and from the voltage feedback circuit, a second indication that the output voltage of the power supply circuit has decreased to a second voltage; and in response to the second indication, increase the first duty cycle to a second duty cycle greater than the first duty cycle.

Examples may include one of the following features, or any combination thereof. For instance, in some examples of the remote circuit breaker, the power supply circuit comprises a gate driver for activating the switch, and the power supply, when electrically coupled to the external electrical power input and the microcontroller, is configured to isolate the microcontroller from a path of electrical power between the external electrical power input and the one or more solenoids using the gate driver.

In some variations, the power supply circuit comprises an isolated buck converter circuit or a non-isolated buck converter circuit. The switch is a solid state switch.

In some examples, the microcontroller comprises a memory. A duty cycle set comprising the first duty cycle and the second duty cycle is stored in the memory. The microcontroller is further configured to, in response to the second indication, increase the first duty cycle to the second duty cycle based on adjusting the first duty cycle to a next duty cycle in the duty cycle set.

In some instances, the microcontroller further comprises a comparator configured to receive an oscillating voltage triangular waveform and an oscillating threshold voltage from the microcontroller. The microcontroller is further configured to increase the first duty cycle to the second duty cycle based on the oscillating threshold voltage exceeding the oscillating voltage triangular waveform.

In some variations, the one or more solenoids are configured to draw 24V during activation.

In some instances, the external electrical power input comprises a single phase power supply or a single phase current transformer, a two phase power supply or a two phase current transformer, or a three phase power supply or a three phase current transformer.

In some examples, the remote circuit breaker further comprises a low dropout (LDO) regulator electrically coupled between the power supply circuit and the microcontroller and a pulse width modulation (PWM) controller electrically coupled between the microcontroller and the power supply circuit. The power supply circuit is electrically coupled between the external electrical power input and the LDO regulator. The microcontroller is further configured to issue, to the power supply circuit, a trip signal via the PWM controller; and in response to the second indication, increase the first duty cycle to the second duty cycle using the PWM controller.

In some variations, the remote circuit breaker further comprises a capacitor electrically coupled between the power supply circuit and the LDO regulator. The capacitor is configured to discharge when the switch of the power supply circuit activates.

In some examples, the LDO regulator comprises a minimum input-output voltage differential. An output voltage of the power supply circuit received by the LDO regulator is within the minimum input-output voltage.

In another aspect, a system for a remote circuit breaker is provided. The system comprises a wireless transmitter, the wireless transmitter configured to provide a control signal to the remote circuit breaker based on a trip event; and the remote circuit breaker. The remote circuit breaker comprises a wireless receiver configured to receive the control signal; a power supply circuit electrically couplable to the external electrical power input and a microcontroller, the power supply circuit comprising a switch and a one or more solenoids, the power supply circuit configured to activate the switch and electrically couple to the external electrical power input in response to a gate trigger signal thereby receiving direct current (DC) voltage for the one or more solenoids, and configured to provide the DC voltage to the one or more solenoids for activating the one or more solenoids in response to a solenoid signal; a voltage feedback circuit electrically coupled between the power supply circuit and the microcontroller, the voltage feedback circuit configured to sample an output voltage of the power supply circuit when the power supply circuit is electrically coupled to the external electrical power input; and the microcontroller. The microcontroller configured to issue, to the power supply circuit, the gate trigger signal based on the control signal, wherein the power supply circuit electrically couples at a first duty cycle based on the gate trigger signal; issue, to the power supply circuit, the solenoid signal based on receiving a first indication from the voltage feedback circuit of the output voltage at a first voltage; receive, during the extension of the one or more solenoids and from the voltage feedback circuit, a second indication that the output voltage of the power supply circuit has decreased to a second voltage; and in response to the second indication, increase the first duty cycle to a second duty cycle greater than the first duty cycle.

Examples may include one of the following features, or any combination thereof. For instance, in some examples of the system, the power supply circuit comprises a gate driver for activating the switch, and the power supply, when electrically coupled to the external electrical power input and the microcontroller, is configured to isolate the microcontroller from a path of electrical power between the external electrical power input and the one or more solenoids using the gate driver.

In some variations, the power supply circuit comprises an isolated buck converter circuit, and the switch is a solid state switch.

In some examples, the microcontroller comprises a memory. A duty cycle set comprising the first duty cycle and the second duty cycle is stored in the memory. The microcontroller is further configured to, in response to the second indication, increase the first duty cycle to the second duty cycle based on adjusting the first duty cycle to a next duty cycle in the duty cycle set.

In some instances, the microcontroller further comprises a comparator configured to receive an oscillating voltage triangular waveform and an oscillating threshold voltage from the microcontroller. The microcontroller is further configured to increase the first duty cycle to the second duty cycle based on the oscillating threshold voltage exceeding the oscillating voltage triangular waveform.

In some variations, the one or more solenoids are configured to draw 24V during activation.

In some examples, the system further comprises a low dropout (LDO) regulator electrically coupled between the power supply circuit and the microcontroller and a pulse width modulation (PWM) controller electrically coupled between the microcontroller and the power supply circuit. The power supply circuit is electrically coupled between the external electrical power input and the LDO regulator. The microcontroller is further configured to issue, to the power supply circuit, a trip signal via the PWM controller; and in response to the second indication, increase the first duty cycle to the second duty cycle using the PWM controller.

In some instances, the system further comprises a capacitor electrically coupled between the power supply circuit and the LDO regulator. The capacitor is configured to discharge when the switch of the power supply circuit activates.

In some variations, the LDO regulator comprises a minimum input-output voltage differential. An output voltage of the power supply circuit received by the LDO regulator is within the minimum input-output voltage.

In another aspect, a method for operating a remote circuit breaker is provided. The method comprises issuing, by a microcontroller and to a power supply circuit, a gate trigger signal to electrically couple the power supply circuit to an external electrical power input at a first duty cycle; receiving, by the microcontroller and from a voltage feedback circuit sampling an output voltage of the power supply circuit, a first indication of the output voltage at a first voltage; issuing, by the microcontroller and to the power supply circuit, a solenoid signal based on receiving the first indication from the voltage feedback circuit; activating, by the power supply circuit, one or more solenoids; receiving, by the microcontroller and from the voltage feedback circuit during the activation of the one or more solenoids, a second indication that the output voltage has decreased to a second voltage; and in response to the second indication, increasing the first duty cycle to a second duty cycle greater than the first duty cycle.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates an example of a remote circuit breaker according to one or more embodiments of the present disclosure;

FIG. 2 illustrates an example of a circuit for activating a solenoid according to one or more embodiments of the present disclosure;

FIG. 3 illustrates an example of a bridge rectifier circuit according to one or more embodiments of the present disclosure;

FIG. 4 illustrates an example of a buck converter according to one or more embodiments of the present disclosure;

FIG. 5 illustrates an example of a driver circuit according to one or more embodiments of the present disclosure;

FIG. 6 illustrates an example of a voltage feedback circuit according to one or more embodiments of the present disclosure;

FIG. 7 illustrates an example process for tripping a circuit breaker according to one or more embodiments of the present disclosure;

FIG. 8A illustrates an example voltage curve of a power supply circuit after a gate trigger signal is issued according to one or more embodiments of the present disclosure;

FIG. 8B illustrates an example voltage curve of a power supply circuit after a gate trigger signal is issued according to one or more embodiments of the present disclosure;

FIG. 9 illustrates example voltage and current curves of a power supply circuit based on a gate trigger signal according to one or more embodiments of the present disclosure;

FIG. 10 illustrates an example duty cycle set for a power supply circuit according to one or more embodiments of the present disclosure;

FIG. 11 illustrates an example process for determining a duty cycle for a power supply circuit according to one or more embodiments of the present disclosure;

FIG. 12 illustrates an example of a circuit for activating a solenoid according to one or more embodiments of the present disclosure;

FIG. 13 illustrates an example of a circuit for activating a solenoid according to one or more embodiments of the present disclosure; and

FIG. 14 illustrates an example process for adapting a duty cycle of a power supply circuit based on the number of poles of a circuit breaker current according to one or more embodiments of the present disclosure.

### DETAILED DESCRIPTION

Examples of the presented application will now be described more fully hereinafter with reference to the accompanying FIGs., in which some, but not all, examples of the application are shown. Indeed, the application may be exemplified in different forms and should not be construed as limited to the examples set forth herein; rather, these examples are provided so that the application will satisfy applicable legal requirements. Where possible, any terms expressed in the singular form herein are meant to also include the plural form and vice versa, unless explicitly stated otherwise. Also, as used herein, the term “a” and/or “an” shall mean “one or more” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.”

Devices and/or systems are herein disclosed that provide a power supply for a circuit breaker. Examples of these devices and/or systems can provide solutions to the problems in the prior art noted above that were identified by the inventors of the present disclosure. For instance, the present disclosure can provide a power supply for triggering a solenoid (e.g., using DC current) of a circuit breaker to off and/or on position in a reliable manner during open and/or close operations. For instance, in some embodiments of the present disclosure, an open loop buck converter can be configured such that the DC voltage for activating the solenoids is generated during the solenoid trip event to minimize component sizing and spatial demands within the circuit breaker. To begin generating the DC voltage, a solid state switch gate of the buck converter can be triggered by a microcontroller, and the duty cycle of the switch can be adjusted over the course of a trigger event. For example, the duty cycle can be adjusted such that the DC voltage being generated within the power supply circuit reaches a sufficient voltage (e.g., 24V), and then can be held around an operating voltage (e.g., 22V) even when the solenoid plunger is expanded and/or retracted and is consuming the voltage of the buck converter to do so (and therefore reduces the voltage of the buck converter as it does so). For instance, the duty cycle at which the solid state switch is triggered can be ramped-up at a rate (e.g., fixed, dynamic) during the solenoid activation, and can take into account the trip time requirement once the solenoid trip command (e.g., solenoid signal) is issued.

Embodiments of the present disclosure can further provide a reduced power consumption since the power supply circuit can be configured to be operational only during a trip instance, and can avoid a continuous current demand, which can be advantageous in metering applications (e.g., no-load currents). Additionally, and/or alternatively, embodiments can provide increased endurance of the components by increasing their life span (e.g., due to less time in operation). Additionally, and/or alternatively, embodiments of the present disclosure can reduce the size of the inductor of the solenoid and reduce and/or eliminate a capacitor for a power reservoir that would normally be used to provide a stable load voltage/current signals (e.g., for metering accuracy). Additionally, and/or alternatively, a solid state switch (e.g., a metal-oxide-semiconductor field effect transistor (MOSFET) gate) package-size rating can be optimized because the current flow through the switch can be ephemeral rather than continuous. Additionally, and/or alternatively, electromagnetic induction and/or conduction issues can be minimized because the current flow through the solid state switch can be ephemeral rather than continuous. Additionally, and/or alternatively, based on the independence of the power supply circuit, the power supply to the other components of the circuit (e.g., a microcontroller, communications circuits, signal conditioning) can be unaffected during a switching event. Additionally, and/or alternatively, driving an output load can be improved in proportion to the increased demand (e.g., a solenoid with high current demands, longer duration demands, and/or high voltage demands). Additionally, and/or alternatively, the output voltage and/or current can be easily adjusted based on controlling the solid state switch triggering duty cycle.

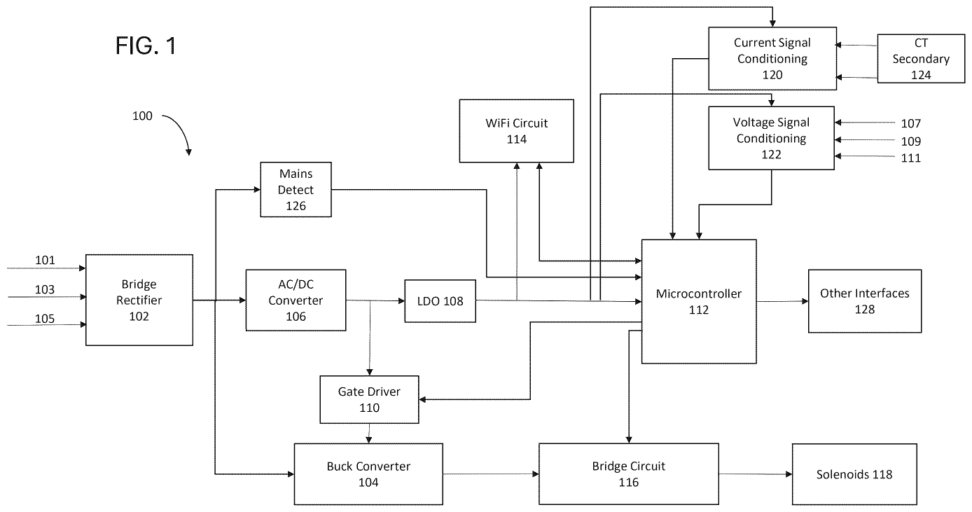

For example, FIG. 1 depicts a schematic diagram of an example remote circuit breaker 100 according to one or more embodiments of the present disclosure, wherein the lines indicate an electrical connection between the components of the circuit breaker 100. The remote circuit breaker 100 is configured to receive a current input and provide a current output, where the circuit is formed between the current input and output when contacts of the circuit breaker 100 are closed (e.g., in the on position). The circuit is configured to be interrupted when the contacts are opened (e.g., in the off position). The contacts can be opened by extension of solenoids 118 (e.g., by pulling or pushing a mechanical switch for opening the contacts). The remote circuit breaker 100 can be operated in a wired and/or wireless configuration (e.g., individually or deployed as part of a larger system), and can be configured to automatically interrupt a circuit of circuit breaker 100 upon receiving an indication of a trip event. Additionally, and/or alternatively to use as a remote circuit breaker, the circuit breaker 100 can be more generally employed in low voltage applications (e.g., that activate solenoids based on an instruction).

A bridge rectifier 102 can receive alternating current (AC) being supplied for the electronics of the circuit breaker 100 (e.g., 120V/60 Hz). For example, the AC current can be received from an L1 line 101, L2 line 103, and a neutral line 105, and the bridge rectifier 102 can provide (e.g., be electrically connected so as to provide) rectified voltage to a power supply circuit, such as a buck converter 104 (e.g., a MOSFET based bucked converter), where the buck converter can convert a higher voltage to a lower voltage at a variable rate based on a duty cycle of the solid state switch (e.g., MOSFET) of the buck converter 104. Additionally, and/or alternatively, the bridge rectifier 102 can provide electrical current to the AC/DC converter 106 that can transform the rectified output to a DC output. The AC/DC converter 106 can provide DC current to both a low dropout (LDO) regulator 108 and a gate driver 110 (e.g., a MOSFET gate driver, isolation device, integrated circuit, and/or transformer). The LDO regulator 108 can be connected between the AC/DC converter 106 and a microcontroller 112, in order to regulate the voltage bring provided to the microcontroller 112. The gate driver 110 can produce increased current for driving a gate (e.g., of the buck converter 104).

The microcontroller 112 can receive current from the LDO regulator 108 and perform various functions for the remote circuit breaker 100. For example, the remote circuit breaker 100 can include a wireless fidelity (WiFi) circuit 114 configured to receive and/or send wireless communications. The WiFi circuit 114 can receive an instruction (e.g., via serial communication) to interrupt the circuit of circuit breaker 100 (e.g., a trip event) and provide this instruction the microcontroller 112. Additionally, and/or alternatively, circuit 100 can include one or more components that can provide current signal conditioning 120 and/or voltage signal conditioning 122. The current signal conditioning 120 (e.g., in association with a CT secondary 124) can detect a trip event based on current (e.g., overcurrent), and provide a signal indicating the trip event to the microcontroller 112. Additionally, and/or alternatively, the voltage signal conditioning 122 can receive a multi-phase current (e.g., an L1 line 107, L2 line 109, and a neutral line 111) and can detect a trip event based on voltage (e.g., excessive load) and provide a signal indicating the trip event to the microcontroller 112. For example, the current signal conditioning 120 and/or voltage signal conditioning 122 can utilize op-amp based signal conditioning and/or a designated metering integrated circuit. The microcontroller 112 can provide (e.g., based on the one or more trip events) one or more signals to one or more electronics of the circuit breaker 100 (e.g., gate driver 110, buck converter 104, and/or bridge circuit 116). Additionally, and/or alternatively, circuit 100 can include a mains detect 126 the presence of a main AC supply for the circuit to determine whether the circuit is open or closed. Additionally, and/or alternatively, the circuit 100 can include further interfaces 128 that the microcontroller 112 interacts with, such as light emitting diodes (LED), buzzers, and/or displays for signaling and/or indicating a status of the breaker.

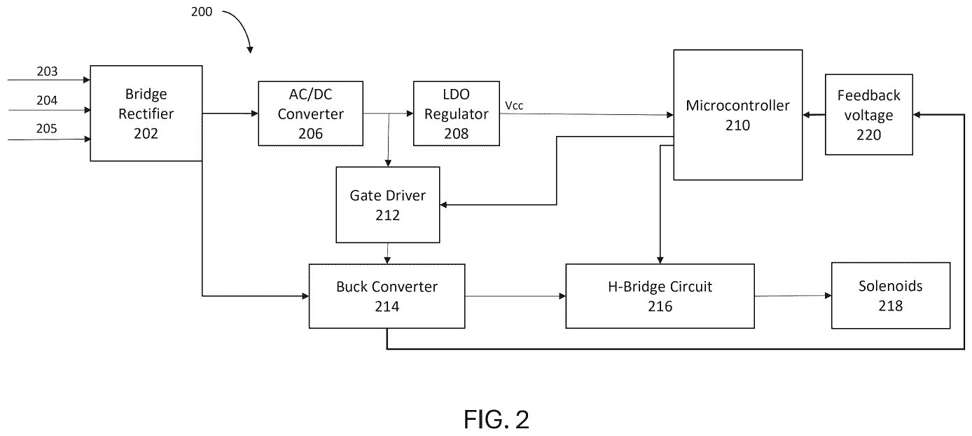

FIG. 2 depicts a schematic diagram of a circuit 200 for tripping a circuit breaker according to one or more embodiments of the present disclosure. The circuit 200 receives power from a bridge rectifier 202. The bridge rectifier 202 can be electrically connected to receive AC current from a line source (e.g., one, two, or three phase current). For example, the AC current can be received from an L1 line 203, L2 line 204, and a neutral line 205. An AC/DC converter 206 (e.g., an integrated circuit such as model number LNK3205) can be electrically connected to the bridge rectifier 202 to receive current and to the LDO regulator 208 to provide DC current to the LDO regulator 208. The LDO regulator 208 can help to maintain a constant DC current to the microcontroller 210 (e.g., for small differences between the voltage supplied from the AC/DC converter 206 and supplied to the microcontroller 210). As a result, the bridge rectifier 202, AC/DC converter 206, and LDO regulator 208 can be connected in series to supply current to the microcontroller 210. In parallel to this series arrangement, the bridge rectifier 202 can be electrically connected to the buck converter 214 to provide current to the buck converter 214. The buck converter 214 can be electrically connected to an H-bridge circuit 216 to provide current to the H-bridge circuit 216. The H-bridge circuit 216 can be electrically connected to the load of one or more solenoids 218 to provide current to the solenoids 218. The one or more solenoids can be triggered separately (e.g., one solenoid activating without the other solenoid activating), and solenoids can be activated for different directions (e.g., one solenoid plunger withdraws and one solenoid plunger extends). The gate driver 212 (e.g., for driving a gate of the buck converter 214) can be electrically connected between the AC/DC converter 206 and the buck converter 214, and receive one or more signals from the microcontroller 210 for operating the gate of buck converter 214. Additionally, and/or alternatively, the gate driver 212 can provide an isolation circuit between the microcontroller 210 and buck converter 214 because the buck converter 214 is in series with the bridge rectifier 202 and can be switched on and off by gate driver 212. The buck converter 214 can be electrically connected to a feedback voltage circuit 220 (e.g., a voltage divider), and the feedback voltage circuit 220 can be electrically connected to the microcontroller 210, to provide an indication of the voltage in the buck converter circuit 214 to the microcontroller 210 (e.g., which, based on the voltage indication, the microcontroller 210 can provide one or more signals for the buck converter 214). As a result, an independent power supply path (e.g., bridge rectifier 202, gate driver 212, buck converter 214, H-bridge circuit 216, one or more solenoids 218) can be provided to the solenoid separate from the rest of the electronics of the circuit.

The circuit 200 can provide many advantages. For example, a steady state power supply that is supplied to the circuit breaker can be unaffected due to solenoid tripping. This can be achieved because the buck converter circuit can be configured to be tripped on only during the tripping event (e.g., around 200 ms). Moreover, based on the H-bridge circuit 216, when at least two solenoids are used by circuit 200, both solenoids can be triggered simultaneously (e.g., for two pole current). Additionally, the circuit 200 can be adapted for different voltage demands and based on different solenoids; according, the same power supply circuit can be used even if a solenoid of the circuit 200 is changed for another solenoid.

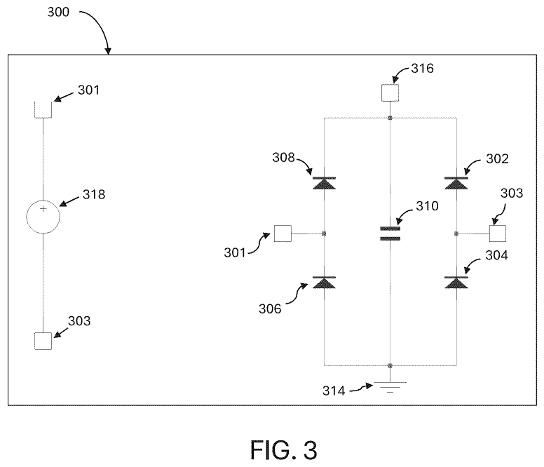

FIG. 3 depicts a schematic diagram of a bridge rectifier circuit 300 (e.g., similar to bridge rectifier 202) that can be used in embodiments of the present disclosure. The circuit 300 contains multiple components such as line phase 301 and N phase 303 for providing current to the rectifier circuit 300, diodes (e.g., diodes 302, 304, 306, 308) arranged (e.g., electrically connected) in a bridge configuration, capacitors (e.g., capacitor 310), and outputs (e.g., output 314, rectified output 316) that that electrically connect the circuit 300 to further circuits. On the left, a simplified AC source diagram is provided showing the sinusoidal current 318 of line phase 301 and N phase 303.

Source 312 is provides the electrical input (e.g., AC) to the bridge rectifier 300, and the bridge rectifier convert the input AC current into DC current. The bridge rectifier performs this conversion using the four diodes 302, 304, 306, and 308, wherein diodes 302, 304 are arranged in series to form a first leg, diodes 306, 308 are arranged in series to form a second leg, and the first and second leg are arranged in parallel to each other. The diodes 302, 304, 306, and 308 can all be arranged in the same direction, allowing current to flow in a single same direction and direct current to the rectified output 316. For example, when the polarity of the input AC current is positive, one leg can conduct current, and when the polarity of the input AC current is negative, the other leg can conduct current, thereby providing an output DC current with the same output polarity regardless of the input AC current polarity. The first leg and second leg can be arranged in parallel to the third leg including a capacitor (e.g., capacitor 310), which can help smooth the rectified DC current (e.g., by filtering current ripples).

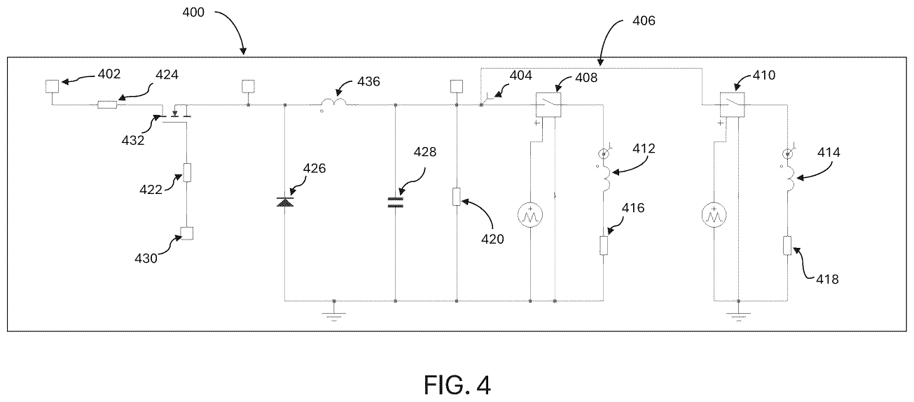

FIG. 4 depicts a schematic diagram of a power supply circuit in the form of a buck converter circuit 400 (e.g., similar to buck converter 214) that can be used in embodiments of the present disclosure. The circuit 400 contains multiple components such as a rectifier 402 that can receive AC and output DC current (e.g., rectifier circuit 300), solid state switches (e.g., MOSFET switch 432), gates (e.g., gate 430, solenoid gates 408, 410) voltage output 404 to an H-bridge 406, inductors (e.g., inductor 436, solenoid inductors 412, 414), diodes (e.g., diode 426), capacitors (e.g., capacitor 428), and resistors (e.g., resistors 416, 418, 420, 422, and 424). The solenoid inductor 412 and resistor 416 together represent a first solenoid, and the solenoid inductor 414 and resistor 418 together represent a second solenoid (e.g., wherein the first and second solenoid together both draw 24V to fully extend).

The input voltage source (e.g., rectifier 402) is located at the head of the circuit 400, and through a resistor 424 (e.g., which can help to limit current in the circuit 400) to other components downstream, including the MOSFET switch 432. The rectifier 402 can provide full wave rectification and/or half wave rectification, and a duty cycle of the circuit 400 can be adjusted based on a full or half wave rectification. The MOSFET switch 432 (and/or a different solid state switch) can serve as the main switching device for the circuit 400, and can be connected in series to a voltage source (e.g., rectifier 402) such that current cannot be provided to the circuit 400 until the MOSFET switch 432 is triggered. The MOSFET switch 432 can be controlled via a driver circuit (e.g., gate driver 212). As described above, a microcontroller (e.g., microcontroller 210) can be used to control the MOSFET switch 432 (e.g., adjusting a duty cycle of the circuit 400 using the MOSFET switch 432). Below the MOSFET switch 432, a flyback diode (e.g. diode 426) can be placed in parallel to a primary current path to provide a path for inductor (e.g., inductor 436) current when the MOSFET switch 432 is switched off. The MOSFET switch 432 and the diode 426 can also be connected in a series-parallel arrangement to switch the input voltage (e.g., from rectifier 402). An inductor 436 can be used with a capacitor 428 (e.g., forming an inductor-capacitor (LC) filter), which can smooth out any pulsing DC waveform into a more stable output voltage (e.g., to the voltage output 404), store oscillating energy, and/or filtering waveforms of a specific frequency. A voltage reference (e.g., voltage output 438), based on resistor 420 in parallel to the capacitor 428 and diode 426, can provide a way to monitor and regulate voltage of the circuit 400 (e.g., in conjunction with microcontroller 210). The first solenoid (e.g., solenoid inductor 412 and resistor 416) and second solenoid (e.g., solenoid inductor 414 and resistor 418) provide the effective load of the circuit (e.g., receiving DC current via H-bridge 406 when solenoid gates 408, 410 are switched on) and can extend to open a circuit of the circuit breaker.

Circuit 400 can electrically connect the solenoid gates 408, 410 to the circuit 400 using an H-bridge 406. Additionally, and/or alternatively, circuit 400 can electrically connect the solenoid gates 408, 410 to the circuit 400 using other switching structures, such as any switching IC, solid state switch, bidirectional MOSFET, insulated-gate bipolar transistor (IGBT), and/or single direction switch. H-bridge 406 can be used to trigger (e.g., activate) the solenoids in both directions (e.g., extension and contraction).

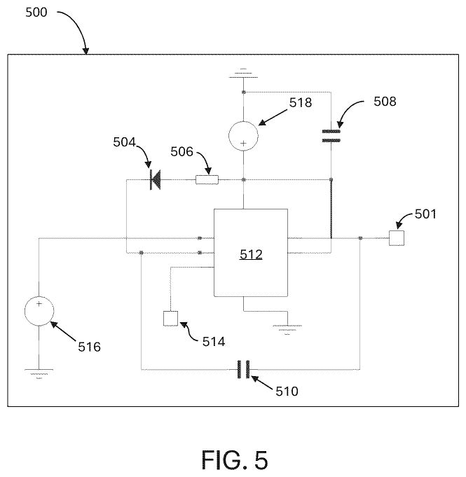

FIG. 5 depicts a schematic diagram of a driver circuit 500 (e.g., similar to gate driver 212) that can be used in embodiments of the present disclosure. The circuit 500 can include multiple components, such as a power source 501, diodes (e.g., diode 504), resistors (e.g., resistor 506), capacitors (e.g., capacitor 508, 510), integrated circuits (e.g., integrated circuit 512) capable of performing various functions such as providing a gate driver for gate 514 (e.g., MOSFET switch 432), and gates (e.g., gate 514). The driver circuit 500 can operate a solid state switch (e.g., MOSFET switch 432) having a given resistance (e.g., 15 Ohms) by receiving an input from the microcontroller and providing high-speed switching signals (e.g., based on providing sufficient voltage and/or current to gate 514). For example, the driver circuit 500 can receive control signals (e.g., from a microcontroller and received at the integrated circuit 512) and perform various functions based thereon, such as amplifying them to drive gate 514. Additionally, and/or alternatively, the driver circuit 500 can utilize many specific types of components that allow for isolation of the microcontroller from the solid state switch (e.g., MOSFET switch 432).

A DC source 516 (e.g., 8V) can provide an input voltage source connected to the integrated circuit 512. The diode 504 and resistor 506 are arranged (e.g., electrically connected) in series, and ultimately are connected to the integrated circuit 512. The diode 504 and resistor 506 series arrangement can regulate and/or protect part of the circuit 500, such as be providing a regulated current flow to the integrate circuit 512. The integrated circuit 512 can provide multiple connections for power input and output, in addition to control inputs and outputs (e.g., for driving MOSFET switch 432 of circuit 400). The capacitor 510 (e.g., connected between inputs of the integrated circuit 512) can help to stabilize voltage provide to the integrated circuit 512. A further capacitor 508 can be connected in parallel to a voltage source 518. The integrated circuit 512 can operate gate 514, for example by using a Boolean function wherein the gate outputs a 1 based on one or more inputs received from the integrated circuit 512.

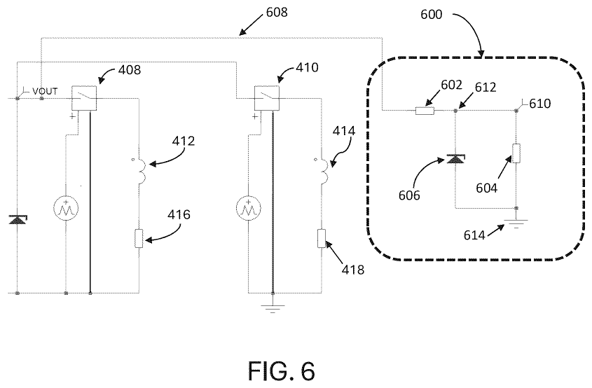

FIG. 6 depicts a schematic diagram of a voltage feedback circuit 600 (e.g., similar to the voltage feedback circuit 220) shown inside the dashed box 602 that can be used in embodiments of the present disclosure. The voltage feedback circuit 600 (e.g., a divider circuit and/or other circuit than can measure instantaneous voltage) can receive DC current from a power supply circuit (e.g., solenoids of buck converter circuit 400 shown for reference), sample the voltage of the power supply circuit, and provide an indication of the voltage in the power supply circuit to a microcontroller (e.g., microcontroller 210). The voltage feedback circuit can include multiple components, such as resistor 602 and 604 and diode 606 (e.g., a Zener diode).

The voltage feedback circuit 600 can receive DC current via an electrical connection 608 to a power supply circuit (e.g., buck converter circuit 400 shown to the left). The voltage feedback circuit can also be electrically connected to a microcontroller, and provide a feedback voltage at connection 610 to the microcontroller, for example based on scaling and stabilizing the input voltage using the resistors 602, 604, and diode 606. The resistor 602 can be arranged between the connection 608 and a junction 612 that is shared by resistor 604 and diode 606 (e.g., arranged in parallel). The diode 606 can be arranged towards (e.g., cathode pointed towards) the junction 612, with the anode directed towards a ground 614. Resistor 604 can be arranged in parallel to diode 606, between connection 610 and ground 614. Together, resistors 602 and 604 can scale down the voltage provided to junction 612 (e.g., provided to a microcontroller). As a result, the resistors 602, 604 can provide a proportional voltage to junction 612, where the proportion of the voltage is based on a ratio of the resistance of resistor 602 and the resistance of resistor 604. The diode 606 can the help to maintain a constant reference voltage at junction 612 (e.g., 3.3V) based on the properties of the diode 606. As a result, so long as voltage received from connection 608 is sufficient high (e.g., enough to bias diode 606), voltage provided to connection 610 can remain substantially stable and/or within a desired range irrespective of voltage fluctuations received from connection 608.

For example, in some embodiments, the buck converter 400 can output a voltage (e.g., 24V) that is too large of a potential to be provided to the microcontroller directly. The voltage feedback circuit 600 can shield the microcontroller from this high voltage by scaling the voltage received via connection 608 down to a manageable voltage at connection 610. As a result, the microcontroller can receive an indication from the voltage feedback circuit 600 of whether the solenoids have begun to extend and draw electrical potential (e.g., voltage) from the power supply circuit.

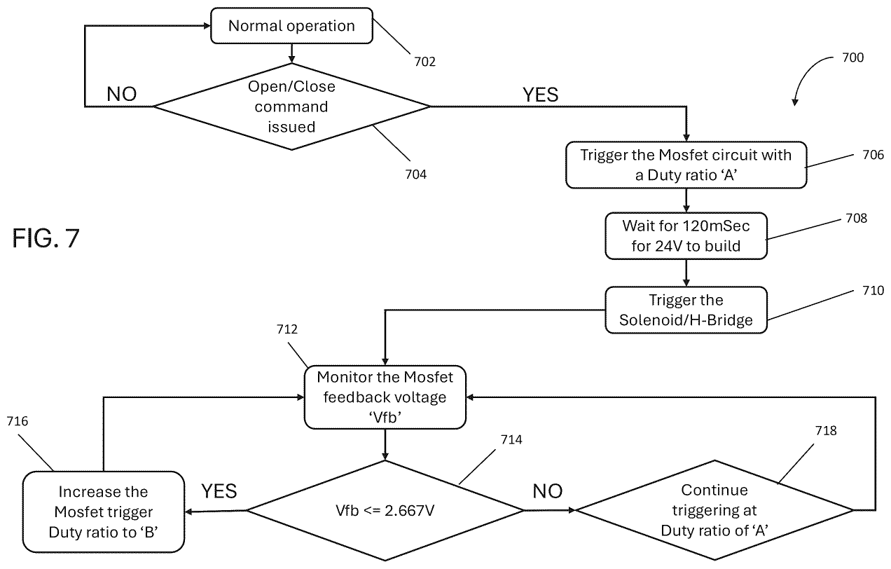

FIG. 7 depicts a process 700 for operating a circuit breaker (e.g., using circuit 200). During normal operation at block 702, the circuit breaker operates normally (e.g., contacts closed, current flowing in circuit of circuit breaker or contacts open, no current flowing in circuit). In this case, no open or close command is issued to the circuit breaker.

Once an open command or a close command is issued at block 704, the solenoids (e.g., solenoids 218) will eventually be activated (e.g., extended for an open command or withdrawn for a close command) to perform the opening or closing of the circuit breaker switch. To do so, a microcontroller (e.g., microcontroller 210) issues a gate trigger signal at block 706 to a power supply circuit (e.g., buck converter circuit 400). The power supply circuit triggers a gate (e.g., MOSFET switch 432) and thereby electrically connects the power supply circuit to a power supply of the circuit breaker (e.g., bridge rectifier 202). Based on the gate trigger signal, the gate triggers the power supply circuit at a first duty cycle. For example, the gate can be configured to only trigger and begin building voltage based on a gate trigger signal.

The microcontroller at block 708 waits for a determined or predetermined period of time (e.g., 120 ms) for a threshold voltage (e.g., 24V) to be reached in the power supply circuit. After the threshold voltage has been achieved in the power supply circuit, the microcontroller issues a solenoid signal at block 710 to activate (e.g., extend for an open command) the solenoids. Additionally, and/or alternatively, the microcontroller can issue the solenoid signal at block 710 based on a predetermined time elapsing after the gate trigger signal is issued.

At block 712, the microcontroller monitors the voltage in power supply circuit based on a voltage indication received from a voltage feedback circuit (e.g., voltage feedback circuit 220). For example, after block 710 when the solenoid signal is issued, the solenoids will consume (e.g., draw) voltage from the power supply circuit to extend. As a result, as the solenoids extend the voltage in power supply circuit will drop based on the voltage used by solenoids (e.g., solenoid inductors 412 and 418). As the voltage drops, the voltage indication provided by the voltage feedback circuit to the microcontroller will drop proportionately.

At block 714, the microcontroller checks whether the voltage indication has dropped below a second voltage (e.g., a trigger threshold voltage of 2.667V). At block 716, the microcontroller determines that the voltage indication has dropped below the second voltage, and increases the duty cycle of the power supply circuit to a second duty cycle, thereby increasing the voltage of the power supply circuit to an operating voltage. The operating voltage can be a fixed and/or semi-oscillating voltage capable of maintaining enough force the solenoids to complete activation. Alternatively, at block 718, the microcontroller determines that the voltage has not dropped below the second voltage (e.g., the voltage indication remains at approximately 3.2V) and maintains the duty cycle of the power supply circuit at the first duty cycle.

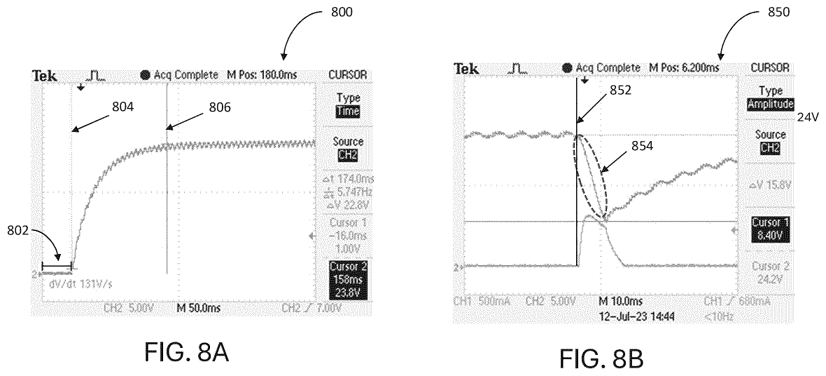

For example, referring back to FIG. 2, the circuit 200 can extend one or more of the solenoids 218 based on issuing, from the microcontroller 210, a gate trigger signal and solenoid signal. The voltage in the power supply circuit (e.g., including the solenoids 218) will vary between issuing the gate trigger signal and the solenoid signal, and after issuing the solenoid signal. As shown in the voltage curve 800 of FIG. 8A, at time 802 (e.g., block 704), a minimal or no voltage is present in the power supply circuit (e.g., buck converter circuit 400). At time 804 (e.g., block 706), the microcontroller issues a gate trigger signal to the power supply circuit, at which point a gate (e.g. MOSFET switch 432) of the power supply circuit trips at a first duty cycle and electrically connects the power supply circuit to a current (e.g., from bridge rectifier 202). From time 804 to 806 (e.g., block 708), voltage builds in the power supply circuit as it receives current. The voltage will build from the minimal voltage (e.g., effectively 0 or 0-2V) to an operational voltage (e.g., a threshold voltage of 24V). Based on (e.g., when, in response to) the microcontroller determining that, at time 806 (e.g., block 710, a voltage indication from a voltage feedback circuit indicates that the power supply circuit has achieved a threshold voltage, the microcontroller will issue a solenoid signal to activate the solenoids (e.g., solenoid 218).

Once activated, the solenoids draw a certain amount of current (e.g., 1-1.4 amps) for a defined amount of time (e.g., 10 ms, 20 ms) to properly extract enough force to fully extend and/or withdraw the plungers of the solenoids. The defined amount of time can vary based on the parameters of the one or more solenoids. As shown in voltage curve 850 of FIG. 8B, at time 852 (e.g., block 710), the solenoid signal has been issued, and the power supply circuit has tripped the gate of the solenoid (e.g., solenoid gate 408 and/or 410). During time 854 (e.g., block 712), the voltage in the power supply circuit drops as the solenoids are activating (e.g., extending or withdrawing) and solenoid current of current curve 880 increases. In other words, the one or more solenoids begin consume current, and as the solenoid activates, the voltage dips. If the duty cycle is kept constant and the voltage drops as in FIG. 8B, the activation of the solenoid weakens, and the solenoid can fail to completely activate. While FIGS. 8A and 8B are disclosed with respect to a 24V sufficient voltage based on example solenoids, other voltages can be used based on different parameters of a power supply circuit and/or solenoid.

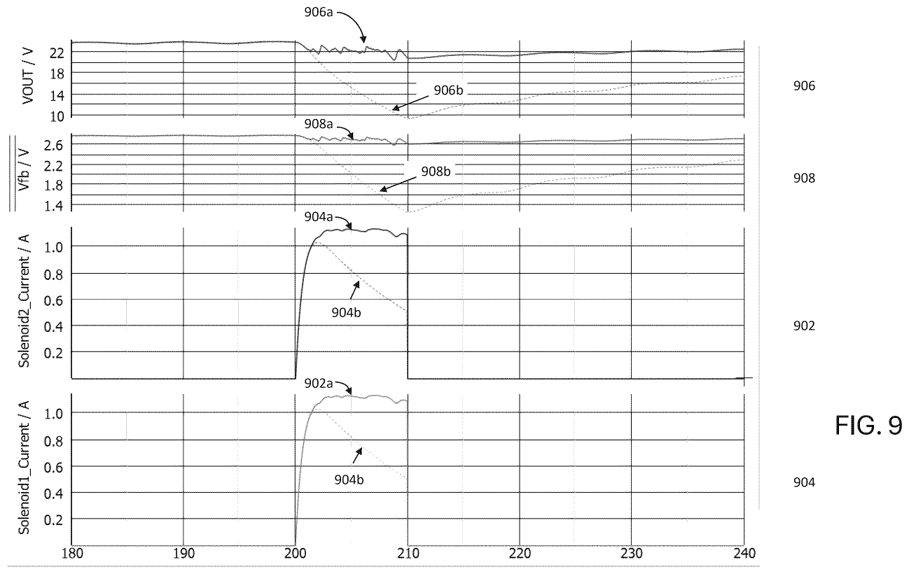

However, by adjusting (e.g., increasing) the duty cycle, the voltage in the power supply circuit can be compensated to provide a substantially constant and sufficient (e.g., operating) power supply to the solenoids. For example, FIG. 9 depicts further example current curves 902, 904 for each solenoid in the power supply circuit, an example voltage curve 906 for the power supply circuit, and an example voltage indication curve 908 of a voltage feedback circuit. As shown in voltage curve 906, from 180 ms to 200 ms (e.g., during block 708) a gate trigger signal has been issued and the voltage in the power supply circuit has built to a sufficient voltage. The current curves 902, 904 remain 0 amp, as the solenoid signal has not been issued. At 200 ms, the microcontroller issues the solenoid signal (e.g., based on a voltage indication indicating that the power supply circuit contains a sufficient voltage) and the solenoids activate. Once the solenoid gates activate (e.g., after block 710), the solenoids activate and the current (e.g., shown current curves 902, 904) in the solenoids builds to an operational current. As the current in the solenoids builds, the voltage in the power supply circuit drops. As shown by voltage curve 906a and 908a, the duty cycle can be increased (e.g., incrementally, adaptively, and/or continuously) to compensate for the solenoid activation and provide an increased voltage relative to voltage curve 906b and 908b, in which the duty cycle is not adjusted (e.g., increased). The duty cycle increase signal (e.g., to adjust the first duty cycle to a second duty cycle) to the power supply gate can be scheduled (e.g., occurring 1-3 ms after issuing the solenoid signal) or can be issued based on determining a voltage indication (e.g., curve 908a) has decreased to a minimum voltage (approximately 2.6V in curve 908a). After the solenoids finish activating (e.g., the plungers are fully extended or withdrawn) approximately 10 ms after the solenoid signal is issued, the current in the solenoids drops back to 0 and the voltage in the power supply circuit begins to recover to the sufficient voltage. The microcontroller can then issue a second gate trigger signal, opening a gate of the power supply circuit and disconnecting the electrical connection of the power supply circuit. As shown by comparison of voltage curve 906a to 906b, voltage curve 908a to 908b, current curve 904a to 904b, and current curve 902a to 902b, by increasing the duty cycle of the power supply circuit, an improved voltage can be generated in the power supply circuit and an improved current can be provided in the solenoids over the duration of the solenoid activation. Additionally, as shown by FIG. 9, the voltage supplied to the solenoids can vary (e.g., as the duty cycle is iteratively increased) and still provide sufficient voltage for the solenoids to effectively activate. As a result, based on the increased duty cycle, the solenoids can continue to activate with an appropriate force.

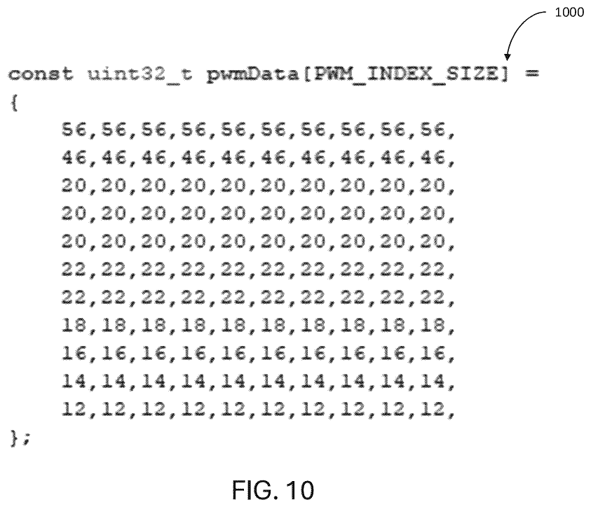

FIG. 10 depicts an example duty cycle set 1000 for a power supply circuit. The set 1000 shows the entries representing the duty ratio (e.g., twice the duty ratio percentage) for a gate of a power supply circuit. For example, when the gate trigger signal is issued, the gate trigger signal can include a duty cycle for a gate of the power supply. According to a predetermined set (e.g., stored in a memory of microcontroller 210), the ratio can be incrementally set and/or adjusted every increment of time (e.g., tenths of milliseconds). Additionally, and/or alternatively, a duty cycle set can be determined live (e.g., each increment of duty cycle determined based on a voltage indication received). In the example duty cycle set 1000, the duty cycle provided upon issued the gate trigger signal can be a ratio of 56 (e.g., time on to time off), and as the voltage builds in the power supply circuit, the duty cycle can be reduced to 46 a millisecond later, then reduced to 20 a millisecond later. The duty cycle can then be increased (e.g., based on issuing a solenoid signal and/or when the solenoids are activating) to a 22 approximately 3 ms later (e.g., to compensate for the drop in voltage as the solenoids activate and draw power from the power supply circuit). As the solenoids reaches the end of activating, the duty cycle can be reduced down to a ratio of 18, 16, 14, then 12. The duty cycle set can be adjusted based on the voltage demands of a given solenoid activation and/or power supply circuit parameter. Additionally, and/or alternatively, the set 1000 entries can be changed based on the kind of solenoid used and any other conditions such as a change in solenoid voltage, impedance or number of turns. For example, as the solenoid wears from use (e.g., gets older and worn out), the duty cycle ratios of the duty cycle can be adjusted in real time by microcontroller. For instance, the microcontroller based on the received voltage indications, can increase the duty cycle dynamically (e.g., skipping duty cycle ratios in the duty cycle set 1000 or deviating from duty cycle set 1000 to duty cycles not listed in duty cycle set 1000) and/or retrieve a different duty cycle set 1000 from memory.

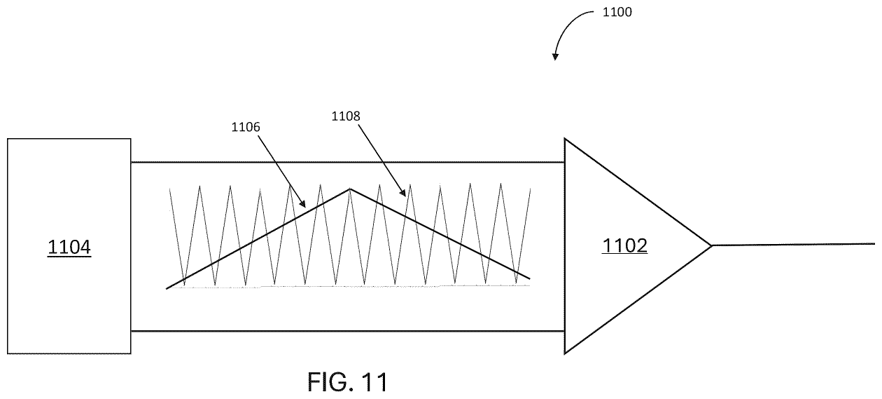

FIG. 11 depicts an alternative and/or additional process 1100 for determining a duty cycle for a power supply circuit. For example, a circuit breaker can include a comparator 1102 electrically connected to a microcontroller 1104. A microcontroller 1104 can generate two different voltage waveforms (e.g., using a designated pin or integrated circuit for each waveform), a ramping voltage waveform 1106 and a triangular voltage waveform 1108. The ramping voltage waveform 1106 can provide a threshold voltage, and the duty cycle can be continuously increased during the time in which the triangular voltage waveform 1108 is less than (e.g., below in FIG. 11) the threshold voltage waveform 1106. In other words, the output of the microcontroller 1104 can be high when the instantaneous value of the triangular voltage waveform 1108 is less than the ramping voltage waveform 1108 (e.g., a DC offset) and low when the triangular voltage waveform 1108 is greater than the ramping voltage waveform 1106. The slope of the ramping voltage waveform 1106 can be adjusted predetermined and stored in memory, or alternatively, determined based on the parameters of a given power supply circuit and/or solenoid to provide a duty ratio adjustment proportionate to those parameters.

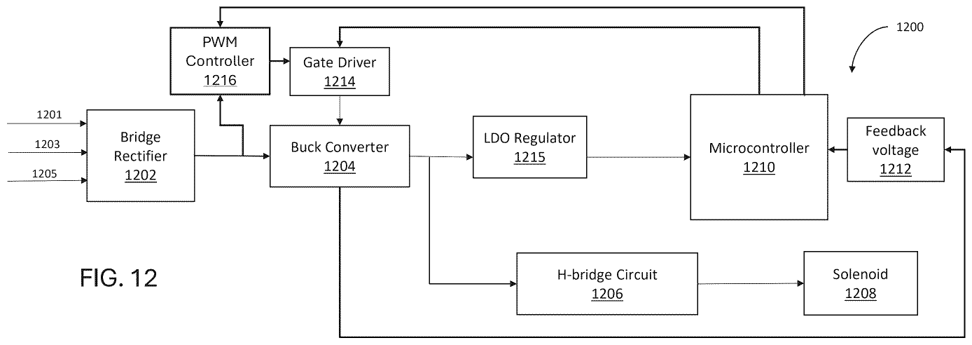

FIG. 12 depicts a schematic diagram of a circuit breaker circuit 1200 for activating a solenoid 1208. The circuit can receive three-phase power similar to circuit 200 (e.g., AC current can be received from an L1 line 1201, L2 line 1203, and a neutral line 1205), and includes components similar to circuit 200, such as a bridge rectifier 1202, a buck converter 1204, an H-bridge circuit 1206, one or more solenoids 1208, a microcontroller 1210, a voltage feedback circuit 1212, an LDO regulator 1215, and a gate driver 1214. Additionally, circuit 1200 includes a pulse-width modulation (PWM) controller 1216 that can generate a signal with a duty cycle (e.g., a preset duty cycle) and operate the gate driver 1214.

While the components of circuit 1200 can individually operate in a similar manner as the corresponding components of circuit 200, additionally, the PWM controller 1216 can be initially triggered by the bridge rectifier 1202 (e.g., after an open or close command such as a signal to open or close a circuit of the circuit breaker is received and before power is provided to microcontroller 1210). Then, once microcontroller 1210 receives a voltage indication from the voltage feedback circuit 1212 that the voltage of the power supply circuit is sufficient (e.g., the buck converter 1204 has achieved 24V after a gate trigger signal issued by the PWM controller 1216), the microcontroller 1210 can issue a signal to the PWM controller 1216 based on the voltage indication for the PWM controller 1216 to control the duty ratio of the buck converter 1204. As a result, in circuit 1200, the triggering of the buck converter 1204, the solenoids 1208, and adjustment of the duty cycle of the power supply circuit (e.g., including buck converter 1204) can be managed by the PWM controller 1216. As a result, an improved start up time can be provided. For example, in some instances the microcontroller 1210 can require additional power and time after an open or close command to start up and give a gate trigger and/or solenoid signal. However, the PWM controller 1216 can receive power before the microcontroller 1210 based on the PWM controller 1216's proximity to bridge rectifier 1202; additionally, the LDO regulator 1215 can take time to power up and start the microcontroller 1210 in addition to the time for the microcontroller 1210 to start up after receiving power from the LDO regulator 1215. As a result, the PWM controller 1216 can start up before the microcontroller 1210 would give the signal. Accordingly, the PWM controller 1216 can provide a reduced start up time delay. In some instances, this reduced start up time delay can be advantageous, such as certain types of faults or fields where standards require fast trip responses.

Additionally, and/or alternatively, the input voltage range (Vmin/Vmax) of the LDO regulator 1215 can be selected such that the solenoid 1218 operational voltage (e.g., 10V, 12V, 24V) is in between Vmin and Vmax. For example, during operation, the LDO regulator 1215 helps to keep a voltage drop across the LDO regulator 1215 (e.g., from an input from a bucl converter 1204 to output to microcontroller 1210) low (e.g., 5 to 3.3V) considering the heat increase inside the LDO regulator 1215. The Vmin (e.g., the minimum voltage from which the LDO regulator 1215 operates) can be less than the minimum voltage during solenoid triggering, and the Vmax can be more than the voltage that is generated across the one or more solenoids (e.g., during a ‘solenoid open’ condition) after adjusting the duty cycle ratio during solenoid tripping. In addition to the advantages mention above that the power-up time of the microcontroller 1210 can be minimized considering the time needed to reach Vmin is far less than time needed to reach 24V, circuit 1200 can also optimize the heat dissipation and temperature increase on the LDO regulator 1215 during normal operation (e.g., no trip condition). Additionally, while the operating voltage (e.g., 22-24V) supplied to the LDO regulator 1215 can be much larger than the Vmin during the tripping operation, the increased voltage supply is only during the tripping operation, and therefore does not present a problem.

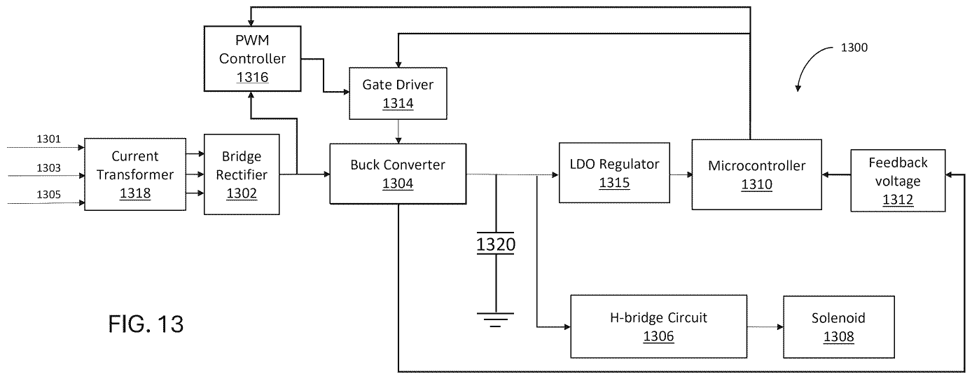

FIG. 13 depicts a schematic diagram of a circuit breaker circuit 1300 for activating a solenoid 1308. The circuit can receive three-phase current transformer power (e.g., from CT line 1301, CT line 1303, and common connection line 1305), and can include components similar to circuit 1200, such as bridge rectifier 1302, a buck converter 1304, and H-bridge circuit 1306, one or more solenoids 1308, a microcontroller 1310, a voltage feedback circuit 1312, an LDO regulator 1315, a gate driver 1314, and a PWM controller 1316. Additionally, circuit 1300 can include a current transformer 1318 for measuring the current of another circuit associated with the circuit breaker (e.g., the circuit which the circuit breaker of circuit 1300 opens and/or closes) and generating (e.g., providing) an alternating current for circuit 1300 that is proportional to the current that it is measuring in its primary. Additionally, the circuit 1300 can include a capacitor 1320 that can act as a power reservoir for circuit 1300.

While the components of circuit 1300 can individually operate in a similar manner as the corresponding components of circuit 1200, additionally, the current transformer 1318 and capacitor 1320 can aid the circuit 1300 in being self-powered. For example, when a gate trigger signal is issued for the buck converter 1304, the capacitor 1320 can discharge additional power to power up the microcontroller 1310 and/or power up the buck converter 1304.

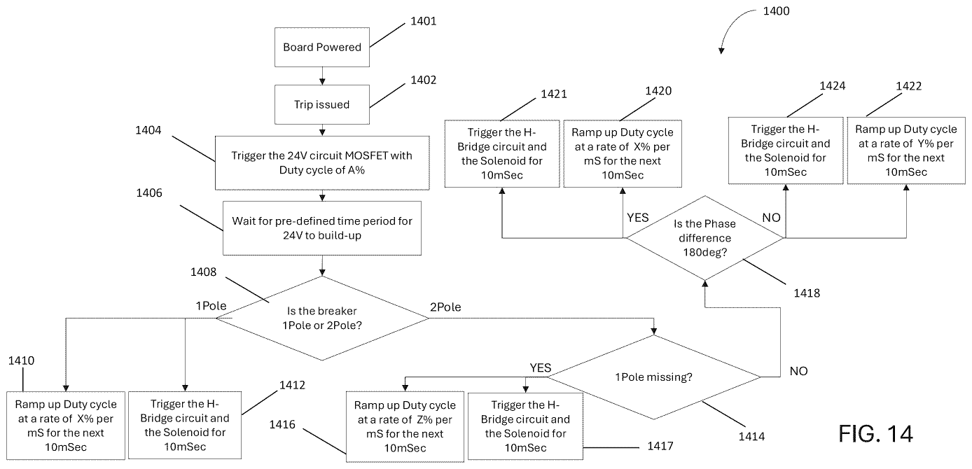

FIG. 14 depicts an example process 1400 for adapting a duty cycle of a power supply circuit based on the number of poles of a circuit breaker current. For instance, a circuit (e.g., circuit 200) can adjust the duty cycle of a power supply circuit based on the number of poles received by the bridge rectifier 202. As a result, one circuit breaker can handle single and/or double pole current configurations, and when multiple solenoids are used, at least two solenoids can be activated simultaneously. For example, in single pole configured breakers (e.g., one line on and another line neutral) a bridge rectifier can be used, and in two pole configured circuit breakers (e.g., designed to be 180 degrees out of phase) two halfwaves can be used from each of the poles, and the process 1400 can account for both (e.g., if a pole is lost in a double pole breaker, operation can be based on a single pole breaker design with a halfwave rectified voltage).

At block 1401, the microcontroller (e.g., a circuit board of the microcontroller 210) is powered up following an open/close command being issued to the circuit breaker. At block 1402, the microcontroller issues a gate trigger signal to begin building voltage in the power supply circuit. At block 1404, the gate switch (e.g., MOSFET switch 432 of circuit 400) is triggered at a first duty cycle ratio. At block 1406, the microcontroller monitors the voltage (e.g., via a voltage indication received from a voltage feedback circuit) in the power supply circuit until the voltage builds to a sufficient voltage (e.g., 24V).

At block 1408, the microcontroller can determine whether the circuit breaker is configured for 1 pole or 2 pole power. At block 1410, having determined that the circuit breaker is configured for 1 pole power, the microcontroller and/or a PWM controller can ramp up the duty cycle at a first rate for a defined time period (e.g., a predetermined time period retrieved from memory or determined based on the 1 pole configuration). For instance, the microcontroller and/or PWM controller can move to a next duty cycle entry in duty cycle set 1000 or adjust the ramping (e.g., threshold) voltage waveform 1106 to provide more instantaneous values in which triangular waveform voltage 1108 is below the voltage waveform 1106. At block 1412, after the defined time period, the microcontroller and/or PWM controller can issue a solenoid signal to trip an H-bridge circuit and the associated gates of one or more solenoids for a second defined time period (e.g., predefined time of 10 ms and/or a time based on the determined parameters of the solenoid).

At block 1414, the microcontroller can alternatively determine that the circuit breaker is configured for 2 pole power, and determines whether a pole of the 2 pole power is missing For example, the microcontroller can determine whether a pole is missing, or both poles are present, based on a signal received from the voltage signal conditioning (e.g., voltage signal conditioning 122). At block 1416, the microcontroller has determined that 1 pole is missing, and the microcontroller and/or PWM controller can ramp up the duty cycle at a second rate (e.g., different than the first rate) for the defined time period similar to block 1410. At block 1417, after the defined time period, the microcontroller and/or PWM controller can issue a solenoid signal to trip an H-bridge circuit and the associated fates of the one or more solenoids for the second defined time period.

At block 1418, the microcontroller determines that no pole is missing, and determines whether the phase difference between the poles is 180 degrees. At block 1420, having determined that the phase difference is 180 degrees, the microcontroller and/or a PWM controller can ramp up the duty cycle at the first rate for the defined time period (e.g., a predetermined time period retrieved from memory or determined based on the 1 pole configuration). At block 1421, after the defined time period, the microcontroller and/or PWM controller can issue a solenoid signal to trip an H-bridge circuit and the associated gates of one or more solenoids for the second defined time period. Alternatively, at block 1422, the microcontroller has determined that the phase difference is not 180 degrees, and the microcontroller and/or PWM controller can ramp up the duty cycle at a third rate (e.g., different than the first rate and second rate) for the defined time period similar to block 1410. At block 1424, after the defined time period, the microcontroller and/or PWM controller can issue a solenoid signal to trip an H-bridge circuit and the associated fates of the one or more solenoids for the second defined time period.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A remote circuit breaker that receives power from an external electrical power input, comprising:
a power supply circuit electrically couplable to the external electrical power input and a microcontroller, the power supply circuit comprising a switch and one or more solenoids, the power supply circuit configured to activate the switch and electrically couple to the external electrical power input in response to a gate trigger signal thereby receiving direct current (DC) voltage for the one or more solenoids, and configured to provide the DC voltage to the one or more solenoids for activating the one or more solenoids in response to a solenoid signal;
a voltage feedback circuit electrically coupled between the power supply circuit and the microcontroller, the voltage feedback circuit configured to sample an output voltage of the power supply circuit when the power supply circuit is electrically coupled to the external electrical power input; and
the microcontroller, the microcontroller configured to:
issue, to the power supply circuit, the gate trigger signal based on a trip event, wherein the power supply circuit electrically couples at a first duty cycle based on the gate trigger signal;
issue, to the power supply circuit, the solenoid signal based on receiving a first indication from the voltage feedback circuit of the output voltage at a first voltage;
receive, during the extension of the one or more solenoids and from the voltage feedback circuit, a second indication that the output voltage of the power supply circuit has decreased to a second voltage; and
in response to the second indication, increase the first duty cycle to a second duty cycle greater than the first duty cycle.

2. The remote circuit breaker of claim 1, wherein the power supply circuit comprises a gate driver for activating the switch, and the power supply, when electrically coupled to the external electrical power input and the microcontroller, is configured to isolate the microcontroller from a path of electrical power between the external electrical power input and the one or more solenoids using the gate driver.

3. The remote circuit breaker of claim 1, wherein the power supply circuit comprises an isolated buck converter circuit or a non-isolated buck converter circuit, and wherein the switch is a solid state switch.

4. The remote circuit breaker of claim 1, wherein the microcontroller comprises a memory, wherein a duty cycle set comprising the first duty cycle and the second duty cycle is stored in the memory, and wherein the microcontroller is further configured to:
in response to the second indication, increase the first duty cycle to the second duty cycle based on adjusting the first duty cycle to a next duty cycle in the duty cycle set.

5. The remote circuit breaker of claim 1, wherein the microcontroller further comprises a comparator configured to receive an oscillating voltage triangular waveform and an oscillating threshold voltage from the microcontroller, and wherein the microcontroller is further configured to:
increase the first duty cycle to the second duty cycle based on the oscillating threshold voltage exceeding the oscillating voltage triangular waveform.

6. The remote circuit breaker of claim 1, wherein the one or more solenoids are configured to draw 24V during activation.

7. The remote circuit breaker of claim 1, wherein the external electrical power input comprises a single phase power supply or a single phase current transformer, a two phase power supply or a two phase current transformer, or a three phase power supply or a three phase current transformer.

8. The remote circuit breaker of claim 1, further comprising a low dropout (LDO) regulator electrically coupled between the power supply circuit and the microcontroller and a pulse width modulation (PWM) controller electrically coupled between the microcontroller and the power supply circuit, wherein the power supply circuit is electrically coupled between the external electrical power input and the LDO regulator, and wherein the microcontroller is further configured to:
issue, to the power supply circuit, a trip signal via the PWM controller; and
in response to the second indication, increase the first duty cycle to the second duty cycle using the PWM controller.

9. The remote circuit breaker of claim 8, further comprising a capacitor electrically coupled between the power supply circuit and the LDO regulator, and wherein the capacitor is configured to discharge when the switch of the power supply circuit activates.

10. The remote circuit breaker of claim 8, wherein the LDO regulator comprises a minimum input-output voltage differential, and wherein an output voltage of the power supply circuit received by the LDO regulator is within the minimum input-output voltage.

11. A system for a remote circuit breaker, the system comprising:
a wireless transmitter, the wireless transmitter configured to provide a control signal to the remote circuit breaker based on a trip event; and
the remote circuit breaker, the remote circuit breaker comprising:
a wireless receiver configured to receive the control signal;
a power supply circuit electrically couplable to the external electrical power input and a microcontroller, the power supply circuit comprising a switch and a one or more solenoids, the power supply circuit configured to activate the switch and electrically couple to the external electrical power input in response to a gate trigger signal thereby receiving direct current (DC) voltage for the one or more solenoids, and configured to provide the DC voltage to the one or more solenoids for activating the one or more solenoids in response to a solenoid signal;
a voltage feedback circuit electrically coupled between the power supply circuit and the microcontroller, the voltage feedback circuit configured to sample an output voltage of the power supply circuit when the power supply circuit is electrically coupled to the external electrical power input; and
the microcontroller, the microcontroller configured to:
issue, to the power supply circuit, the gate trigger signal based on the control signal, wherein the power supply circuit electrically couples at a first duty cycle based on the gate trigger signal;
issue, to the power supply circuit, the solenoid signal based on receiving a first indication from the voltage feedback circuit of the output voltage at a first voltage;
receive, during the extension of the one or more solenoids and from the voltage feedback circuit, a second indication that the output voltage of the power supply circuit has decreased to a second voltage; and
in response to the second indication, increase the first duty cycle to a second duty cycle greater than the first duty cycle.

12. The system of claim 11, wherein the power supply circuit comprises a gate driver for activating the switch, and the power supply, when electrically coupled to the external electrical power input and the microcontroller, is configured to isolate the microcontroller from a path of electrical power between the external electrical power input and the one or more solenoids using the gate driver.

13. The system of claim 11, wherein the power supply circuit comprises an isolated buck converter circuit, and wherein the switch is a solid state switch.

14. The system of claim 11, wherein the microcontroller comprises a memory, wherein a duty cycle set comprising the first duty cycle and the second duty cycle is stored in the memory, and wherein the microcontroller is further configured to:
in response to the second indication, increase the first duty cycle to the second duty cycle based on adjusting the first duty cycle to a next duty cycle in the duty cycle set.

15. The system of claim 11, wherein the microcontroller further comprises a comparator configured to receive an oscillating voltage triangular waveform and an oscillating threshold voltage from the microcontroller, and wherein the microcontroller is further configured to:
increase the first duty cycle to the second duty cycle based on the oscillating threshold voltage exceeding the oscillating voltage triangular waveform.

16. The system of claim 11, wherein the one or more solenoids are configured to draw 24V during activation.

17. The system of claim 11, further comprising a low dropout (LDO) regulator electrically coupled between the power supply circuit and the microcontroller and a pulse width modulation (PWM) controller electrically coupled between the microcontroller and the power supply circuit, wherein the power supply circuit is electrically coupled between the external electrical power input and the LDO regulator, and wherein the microcontroller is further configured to:
issue, to the power supply circuit, a trip signal via the PWM controller; and
in response to the second indication, increase the first duty cycle to the second duty cycle using the PWM controller.

18. The system of claim 17, further comprising a capacitor electrically coupled between the power supply circuit and the LDO regulator, and wherein the capacitor is configured to discharge when the switch of the power supply circuit activates.

19. The system of claim 17, wherein the LDO regulator comprises a minimum input-output voltage differential, and wherein an output voltage of the power supply circuit received by the LDO regulator is within the minimum input-output voltage.

20. A method for operating a remote circuit breaker, the method comprising:
issuing, by a microcontroller and to a power supply circuit, a gate trigger signal to electrically couple the power supply circuit to an external electrical power input at a first duty cycle;
receiving, by the microcontroller and from a voltage feedback circuit sampling an output voltage of the power supply circuit, a first indication of the output voltage at a first voltage;
issuing, by the microcontroller and to the power supply circuit, a solenoid signal based on receiving the first indication from the voltage feedback circuit;
activating, by the power supply circuit, one or more solenoids;
receiving, by the microcontroller and from the voltage feedback circuit during the activation of the one or more solenoids, a second indication that the output voltage has decreased to a second voltage; and
in response to the second indication, increasing the first duty cycle to a second duty cycle greater than the first duty cycle.
